(19) United States
(12) Patent Application Publication
(10) Pub. No.: US 2004/0134132 A1
(43) Pub. Date: Jul. 15, 2004

(54) Sealing and guiding strips

(76) Inventor: Michael Baumann, Nettetal (DE)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(21) Appl. No.: 10/469,067

(22) PCT Filed: Feb. 26, 2002
(86) PCT No.: PCT/IB02/00846

(30) Foreign Application Priority Data
Feb. 27, 2001 (GB) 0104871.9

(51) Int. Cl. E06B 7/16

(52) U.S. Cl. 49/441

(57) ABSTRACT

A window glass sending and guiding channel has a base (22) and side walls (25, 26). One of the side walls (25) carries a lip (29) extending partway across the mouth of the channel, and the opposite side wall (26) carries a similar though smaller lip (30). The lips (29, 30) carry respective applied layers of flock (46). A further lip (24) is mounted on the outside of one (25) of the side walls of the channel and extends past the mouth of the channel to overlap one of the side walls of a stiff mounting frame (20). In addition, this further lip (24) is pressed overlappingly against a terminating edge of the flocked layer (46) on the lip (29), to form a sharp and visually pleasing linear edge (29A) along the flocked area (46). This therefore hides a possibly ragged edge to the flocked area (46) on the lip (29).

### CROSS-REFERENCE TO RELATED APPLICATIONS

Not applicable.

### BACKGROUND OF THE INVENTION

1. Field of the Invention

The invention relates to a sealing and guiding channel-shaped strip for mounting in a support in use and sealingly and guidingly receiving a panel-like member which enters through the mouth of the channel, in which from the distal edge of one side wall alongside the mouth of the channel a first lip made of flexible material extends partway across the mouth of the channel, the externally facing surface of this lip carrying an applied surface layer which extends over the lip from a region near the distal edge of the lip to a termination on the outside of the said one side wall for bearing against a side surface of the panel-like member when in the channel, and a second lip made of flexible material is positioned on the outside of the said one side wall and extends alongside that wall and outwardly of the mouth of the channel, the material of the second lip being in overlapping contact with the said termination of the applied layer. Seals and guiding strips embodying the the invention, and to be described below by way of example only, are for use in sealing and guiding slidable panes of window glass in motor vehicle bodies.

2. Description of Related Art

U.K. Patent Specification No. 2085513 shows such a strip as is set out above. In this strip, however, the first and second lips are parts of respectively separate channels which are adhesively or otherwise secured together. Such an arrangement is relatively complex to make.

### BRIEF SUMMARY OF THE INVENTION

In accordance with the invention, the strip as first set forth above is characterised in that the second lip extends integrally from a position on the outside of the said one side wall which is spaced from the mouth of the channel so as to be pressed into the overlapping contact with the said termination to produce a sharp visually apparent linear edge thereto when the channel is mounted on the support.

In this way, the first and second lips can be integrally produced and become pressed together to produce an improved appearance when the channel is mounted in the support

### BRIEF DESCRIPTION OF THE DRAWINGS

Sealing and guiding strips in the form of window channels for windows in motor vehicle bodies, and embodying the invention, will now be described, by way of example only, with reference to the accompanying diagrammatic drawings in which:

FIG. 1 is a side view of a vehicle door;

FIG. 2 is a cross-section on the line II-II of FIG. 1 to an enlarged scale; and

FIG. 3 corresponds to FIG. 2 but shows a modification.

### DETAILED DESCRIPTION OF THE EMBODIMENTS OF THE INVENTION

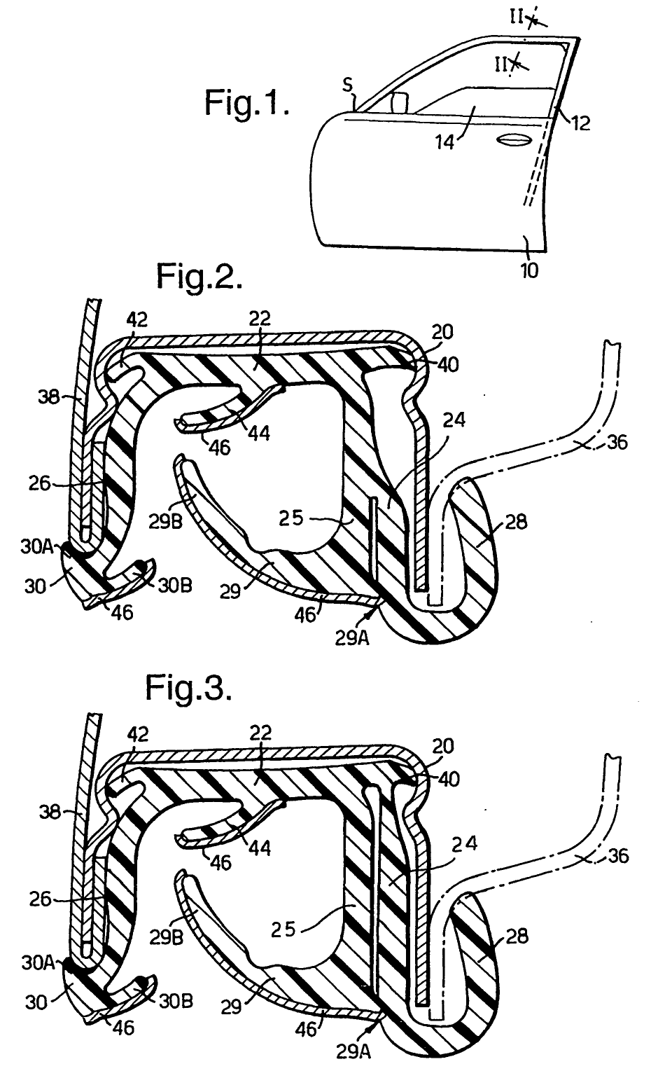

FIG. 1 shows a vehicle door 10 carrying a window frame 12. A pane of window glass 14 is slidable in a vertical direction in the window frame 12 and can be raised from and lowered into the lower part of the door 10. The window frame 12 is produced from metal or other stiff material. In a manner to be explained in more detail, the window frame 12 is of channel-shape in cross-section and supports a window guiding and sealing channel, to be described in more detail below with reference to FIGS. 2 and 3, which is produced from flexible material such as plastics or rubber and in which the window glass 14 slides. The window sealing and guiding channel is designed to provide a weather-proof seal for the edge of the window glass and also to impose only low friction on the movement of the glass.

As shown in FIG. 2, the window frame 12 comprises channel-shaped metal which produces a mounting channel 20, the mounting channel being supported by frame members 36 and 38 forming part of the window frame.

The window sealing and guiding channel is preferably produced by extrusion from the plastics or rubber or similar material and has a base 22 and side walls 25 and 26. The side wall 25 terminates in a large lip 29 extending for a substantial distance across the mouth of the channel. The side wall 26 terminates in a small lip 30 which has a portion 30B extending for a short distance across the mouth of the channel and another part 30A which overlaps the distal edge of the side wall of the mounting channel 20 which is supported by the panel 38.

On the outside of the side wall 25, there is integrally mounted a further lip 24 which has its root positioned approximately at the mid-point of the depth of the side wall 25 and which is curved over as shown at 28 to overlap the distal edge of the opposite side wall of the mounting channel 20, where it is supported by the panel 36.

The window sealing and guiding channel defines shoulders 40 and 42 on the outsides of the side walls 24 and 25 and positioned near the base 22 of the channel. The shoulders 40,42 engage indentations formed in the mounting channel 20 and thus locate the window sealing and guiding channel securely in position.

FIG. 2 also shows that the window sealing and guiding channel includes a lip 44 at the base of the channel.

The outwardly facing surfaces of the lips 29,30 and 44 are covered with flocked layers 46.

In operation, the window glass enters the window sealing and guiding channel as the window is closed, the lip surfaces 29B and 30B being bent inwardly to allow passage of the window glass. The flocked layers 46 provide improved sealing and low friction. When the window glass has fully entered the sealing and guiding channel, it makes contact with the flocked layer 46 on the lip 44 which seals against the distal edge of the window glass.

When the window sealing and guiding channel is mounted in the mounting channel 20 as shown in FIG. 2, the material of the lip 25 becomes pressed firmly against and overlaps a line shown at 29A which corresponds with the linear edge of the flocked layer 46 on the lip 29. A sharp and visually pleasing line of separation between the flocked layer 26 on the lip 29 and the unflocked surface of the lip 24 is thus produced at 29A.

When applying a flocked layer, it is very difficult to produce a sharp linear edge to the flocked area. The arrangement shown in FIG. 2 thus overcomes this disadvantage by abutting the flocked layer 46 against the unflocked area of the lip 24.

Items in FIG. 3 corresponding to those in FIG. 1 are correspondingly referenced.

In the arrangement of FIG. 3, the lip 24 is not integral with the outside of the wall 25 but is integral with the shoulder 40 extending from the base 22 of the window sealing and guiding channel. Otherwise, though, the construction is the same. In particular, the sharp edge 29A between the flocked area 46 on the lip 24 and the unflocked area of the lip 24 is again produced.

1. A sealing and guiding channel-shaped strip mounting in a support (20) in use and for sealingly and guidingly receiving a panel-like member (14) which enters through the mouth of the channel, in which from the distal edge of one side wall (25) alongside the mouth of the channel a first lip (29) made of flexible material extends partway across the mouth of the channel, the externally facing surface of this lip carrying an applied surface layer (46) which extends over the lip (29) from a region near the distal edge of the lip to a termination (29A) on the outside of the said one side wall (25) for bearing against a side surface of the panel-like member (14) when in the channel, and a second lip (24) made of flexible material is positioned on the outside of the said one side wall (25) and extends alongside that wall and outwardly of the mouth of the channel, the material of the second lip (24) being in overlapping contact with the said termination (29A) of the applied layer (46), characterised in that the second lip (2A) extends integrally from a position on the outside of the said one side wall (25) which is spaced from the mouth of the channel so as to be pressed into the overlapping contact with the said termination (29A) to produce a sharp visually apparent linear edge thereto when the channel is mounted on the support (20):

2. A strip according to claim 1, characterised in that the said position on the outside of the said one side wall (25) is substantially mid-way of the depth of the said one side wall (25).

3. A strip according to claim 1, characterised in that the said position on the outside of the said one side wall (25) is a position in the region of the base of the channel.

4. A strip according to any preceding claim, characterised in that the second lip (24) extends outwardly and embracingly around part of the support (20) for the channel.

5. A strip according to claim 4, characterised in that the support (20) for the channel comprises a stiff channel-shaped frame in which is received the sealing and guiding channel, the second lip (24) embracing a distal edge of one side wall of this stiff frame.

6. A strip according to any preceding claim, characterised in that another lip (30), made of flexible material, extends partway across the mouth of the channel from the distal edge of the opposite side wall (26) thereof.

7. A strip according to claim 6, characterised in that the externally facing surface of the lip (30) extending from the opposite side wall carries an applied surface layer (46).

8. A strip according to any preceding claim, characterised in that the or each applied surface layer (30) is a layer of applied flock.

9. A strip according to any preceding claim, characterised in that it is for use as a window sealing and guiding channel in a motor vehicle body and where the panel-like member is the window glass (14).
